(19) United States
(12) Patent Application Publication
(10) Pub. No.: US 2007/0230500 A1
(43) Pub. Date: Oct. 4, 2007

(54) Methods and apparatus for resource selection using detected data throughput

(75) Inventors: John Spenik, Phoenix, AZ (US); Brian Woodbury, Gilbert, AZ (US); Roc Lastinger, Cave Creek, AZ (US)

Correspondence Address: LETHAM LAW FIRM, LLC, 914 N. TUCANA LANE, GILBERT, AZ, 85234, US

(73) Assignee: Rotani, Inc., Scottsdale, AZ (US)

(21) Appl. No.: 11/731,002

(22) Filed: Mar. 29, 2007

Related U.S. Application Data
(60) Provisional application No. 60/743,897, filed on Mar. 29, 2006.

(51) Int. Cl. H04J 3/22

(52) U.S. Cl. 370/465

(57) ABSTRACT

A method for detecting a data throughput and selecting a combination of resources for communicating is performed by a wireless cell having at least two resources. The method includes in any practical order, establishing communication between the wireless cell and a provided wireless client; transmitting a data pattern; receiving the data pattern; detecting a data throughput; repeating transmitting, receiving, and detecting for each resource; and responsive to detecting, selecting the combination of resources for communicating with the wireless client.

### CROSS-REFERENCE TO RELATED APPLICATIONS

This application claims priority under 35 U.S.C. § 119(e) from U.S. patent application 60/743,897 filed Mar. 29, 2006, herein incorporated by reference.

### FIELD OF THE INVENTION

This invention pertains generally to wireless communication, and more particularly to methods and apparatus for selecting resources for communication using detected data throughput.

### BACKGROUND OF THE INVENTION

Wireless devices select resources (e.g., channel, antenna, communication protocol, modulation, demodulation) to provide suitable communication with other wireless devices. Wireless devices select a channel to provide suitable communication. Wireless devices equipped with more than one antenna and/or capable of communicating on more than one antenna may select an antenna that provides suitable communication. Conventional wireless devices use a variety of methods (e.g., signal quality, signal-to-noise ratio) for determining whether a channel and/or an antenna may provide suitable communication. A wireless device may benefit from selecting resources in response to detected data throughput. A wireless device may also benefit from detecting data throughput while communicating with other wireless devices using a conventional communication protocol.

### BRIEF SUMMARY OF THE INVENTION

A method for detecting a data throughput and selecting a combination of resources for communicating is performed by a wireless cell having at least two resources. The method includes in any practical order, establishing communication between the wireless cell and a provided wireless client; transmitting a data pattern; receiving the data pattern; detecting a data throughput; repeating transmitting, receiving, and detecting for each resource; and responsive to detecting, selecting the combination of resources for communicating with the wireless client.

A method for detecting a data throughput and selecting a combination of resources for communicating between a wireless cell and a wireless client is performed by the wireless cell having at least two resources and the wireless client having at least two resources. The method includes in any practical order, receiving a data pattern; detecting a data throughput; repeating receiving, and detecting for each resource; and responsive to detecting, selecting the combination of resources for communicating.

A method for detecting a data throughput and selecting a combination of resources for communicating between a first wireless client and a second wireless client is performed by the first wireless client and the second wireless client. The first wireless client having at least two resources and the second wireless client having at least two resources. The method includes in any practical order, associating with a provided wireless cell; transmitting a data pattern to the other wireless client; receiving the data pattern from the other wireless client; detecting a data throughput; repeating transmitting, receiving, and detecting for each resource; and responsive to detecting, selecting the combination of resources for communicating.

### BRIEF DESCRIPTION OF THE DRAWING

Implementations of the present invention will now be further described with reference to the drawing, wherein like designations denote like elements, and:

FIG. 1 is a diagram of a wireless cell having four antennas, a wireless client having four directional antennas, and a link monitor, according to various aspects of the present invention;

FIG. 2 is a diagram of a wireless cell having four directional antennas, a wireless client having four directional antennas, and two link monitors, according to various aspects of the present invention;

FIG. 3 is a data flow diagram of a method for detecting data throughput and selecting resources, according to various aspects of the present invention;

FIG. 4 is a data flow diagram of a method for detecting data throughput and selecting antennas and channels, according to various aspects of the present invention;

FIG. 5 is a diagram of a wireless cell having an omni-directional antenna, a first wireless client having an omni-directional antenna, and a second wireless client having an omni-directional antenna, according to various aspects of the present invention;

FIG. 6 is a diagram of a wireless cell having an omni-directional antenna, a first wireless client having an omni-directional antenna, and a second wireless client having four directional antennas, and two link monitors, according to various aspects of the present invention;

FIG. 7 is a data flow diagram of a method detecting data throughput and selecting resources performed by for two wireless clients, according to various aspects of the present invention; and

FIG. 8 is a diagram of a wireless network having a link monitor, according to various aspects of the present invention.

### DETAILED DESCRIPTION OF PREFERRED EMBODIMENTS

This application incorporates by reference U.S. application Ser. No. 10/869,201 filed on Jun. 15, 2004, and U.S. application Ser. No. 10/880,387 filed on Jun. 29, 2004 in their entirety. This application also incorporates by reference U.S. provisional application Ser. No. 60/484,800 filed on Jul. 3, 2003, and U.S. provisional application Ser. No. 60/493,663 filed on Aug. 8, 2003 in their entirety for the teachings taught therein.

The term “throughput,” as used herein, is the number of bits transmitted and/or received per unit time (e.g., second). Throughput may be generally categorized into two classes, namely total throughput and usable data throughput. Total throughput includes all bits transmitted and/or received over time between two devices. Total throughput includes, for example, overhead required by the communication protocol (e.g., frame headers, checksums), retransmitted data, and data. As used herein, the term “usable data throughput” means the data transmitted and/or received. Usable data throughput excludes, for example, bits dedicated to overhead and retransmitted data. Usable data throughput is also referred to herein as “data throughput.”

A variety of different measures for data throughput exist. For example, minimum, maximum, and average data throughput. As used herein, the term “average data throughput” is the number of data bits transmitted and/or received divided by the period of time of transmission and/or reception. The term “maximum data throughput” is the maximum number of data bits detected per time period during transmission and/or reception. The term “minimum data throughput” is the minimum number of data bits detected per time period during transmission and/or reception. Data throughput may be expressed as a number of bits per second.

Data throughput is influenced by a variety of factors, for example, the presence of noise, receive error, multipath signals, and other forms of interference that required communicating devices to decrease their rate of transmission and/or retransmit data. Data throughput may be increased, for example, by decreasing the influence of noise on reception, decreasing the need to retransmit, increasing the transmission and/or reception rates, and increasing available transmission and/or reception bandwidth.

Data throughput provides indicia of an amount of interference. Detecting data throughput, according to the various aspects of the present invention, provides a wireless device indicia of the effects of interference (e.g., for a selected resource) without direct detection of and/or information about individual types of interference.

Data throughput provides a metric of the communication capabilities of a resource.

Detecting data throughput may be accomplished, according to various aspects of the present invention, by providing a wireless device with data patterns that are transmitted and received.

Data patterns permit a first wireless device to transmit a data pattern to a second wireless device and the second wireless device to detect throughput.

Data patterns permit a first wireless device to transmit a data pattern to a second wireless device, the second wireless device to transmit the data pattern to the first wireless device, and the first wireless device detect throughput.

Data patterns permit a first wireless device to transmit a data pattern to an intermediary wireless device, the intermediary wireless device transmits the data pattern to a second wireless device, and the second wireless device to detect throughput.

The wireless devices may communicate using a conventional communication protocol.

A first wireless device may transmit and receive a data pattern and detect throughput with little or no modification to the operation (e.g., operation consistent with the selected conventional communication protocol) of the second wireless device. First and second wireless devices may detect data throughput with little or no modification to the operation of an intermediary wireless device.

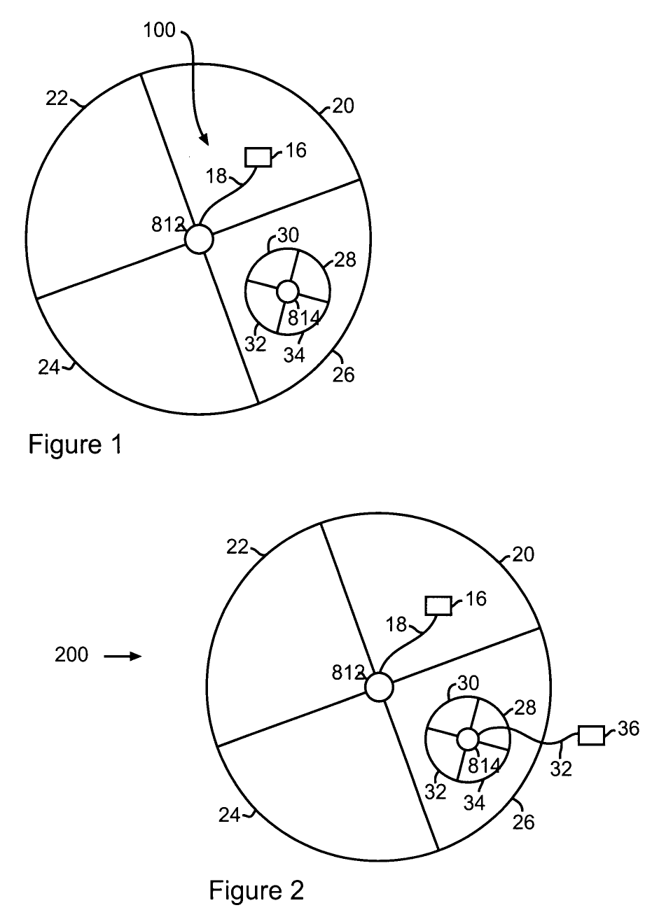

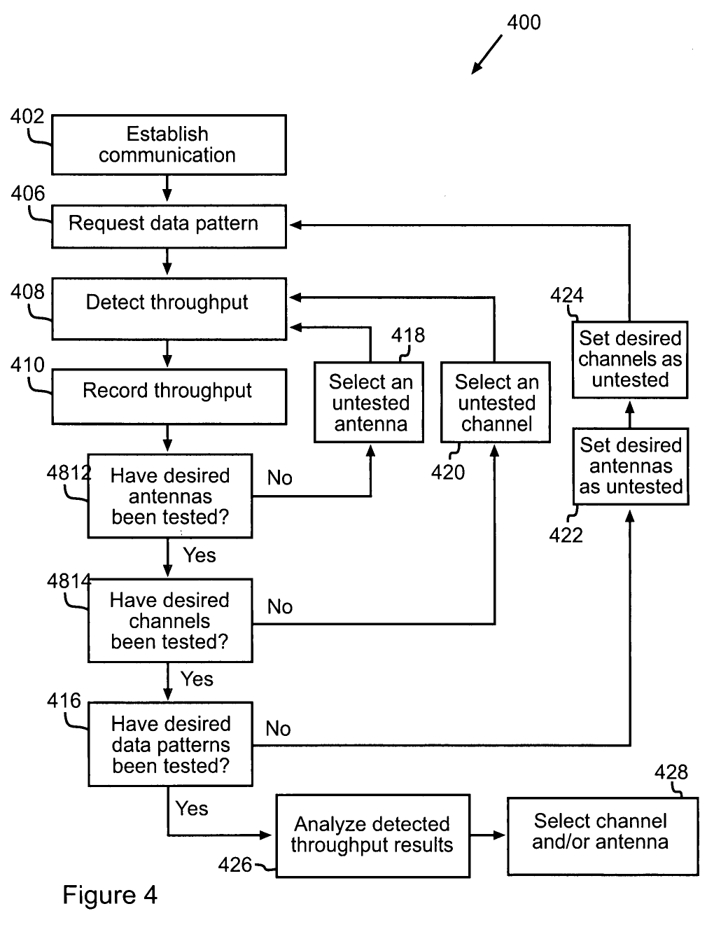

A system for detecting data throughput, referring to the system of FIGS. 1-7, according to various aspects of the present invention, may select a data pattern, transmit the data pattern, receive the data pattern, and detect data throughput. Further, a system for detecting data throughput may select resources for communication in response to the detected throughput.

A system may detect data throughput for a resource (e.g., antenna, radio, channel, attenuator, attenuation setting, data pattern, transmission power setting, directionality of an antenna, antenna gain, communication protocol) and/or a combination of resources.

One implementation of a system may comprise a wireless cell having at least one antenna and a link monitor. The wireless cell may communicate with other wireless devices using a conventional communication protocol. Another implementation of a system may comprise a wireless cell having at least one antenna, a link monitor, and a wireless client having at least one antenna.

Another implementation of a system may comprise a wireless cell having at least one antenna, a first link monitor, a wireless client having at least one antenna, and a second link monitor. The wireless cell is coupled to the first link monitor and the wireless client is coupled to the second link monitor. The wireless cell communicates with the wireless client using a conventional communication protocol.

Another implementation of a system may comprise a first wireless client and a second wireless client that perform, separately or together, a method for detecting throughput. Communication between the first and the second wireless clients is accomplished between an intermediary wireless cell. Performance of the method to detect throughput does not required the wireless cell to operate in a manner that is not consistent with the specification of the selected communication protocol.

In one example of a system, system 100 of FIG. 1 selects a data pattern, transmits the data pattern, receives the data pattern, and detects (e.g., calculates) a data throughput.

System 100 may detect a data throughput for a resource (e.g., antenna, radio, channel, attenuator, attenuation setting, wired connection, data pattern, transmission power setting, directionality of an antenna, communication protocol) and/or a combination of resources.

System 100 may further select a resource and/or a combination of resources for communication responsive to a detected data throughput. Selection of a resource may be in response to the detected data throughput for the resource selected or for any other resource and/or a combination of resources. Criteria for selection of a resource may include detecting a data throughput for the resource greater than a threshold.

System 100 includes a wireless cell 12 and a link monitor 16. Wireless cell 12 may include a processor, a radio, an RF multiplexer, and at least one antenna. The processor may perform calculations. The antennas of wireless cell 12 may be position in such a way to that the physical sectors of the antennas do not overlap and/or do overlap. In one implementation of system 100, wireless cell 12 includes four directional antennas that form non-overlapping physical sectors 20, 22, 24, and 26.

Link monitor 16 may include a processor, a wired and/or wireless communication port, memory circuits (e.g., ROM, RAM, Flash, hard drive), and conventional circuits for storing data, providing data, and performing calculations. Link monitor 16 communicates with wireless cell 12 over link 18.

Wireless cell 12 wirelessly communicates with wireless client 14. Wireless client 14 includes four directional antennas that form non-overlapping physical sectors 28, 30, 32, and 34. No limitation prohibits antenna physical sectors from overlapping, for example, physical sectors 20 may at least partially overlap any physical sectors 22-26. Physical sectors 28, 30, 32, and 34 extend farther than depicted in FIG. 1 to enable communication with wireless cell 12, but they are drawn smaller to clarify the diagram.

Link monitor 16 provides data patterns to wireless cell 12 for detecting data throughput over the wireless connection through each antenna of wireless cell 12 and for each available channel. The results of the data throughput measurements may be used to select the antenna and/or channel used by wireless cell 12 for wireless communication. The operations of link monitor 16 may be performed by the processor of wireless cell 12.

In one implementation using a method of operation, wireless cell 12 and wireless client 14 communicate using a I.E.E.E. 802.11a/b/g protocol. Wireless cell 12 receives a data pattern from link monitor 16. Wireless cell 12 transmits a data pattern to wireless cell 14. In the normal course of operation (e.g., operation consistent with the communication protocol), wireless client 14 transmits the data pattern. Wireless cell 12 receives the data pattern. System 100 uses information gained during transmission and reception of the data pattern to detect a data throughput. In one implementation, the data throughput is detected by wireless cell 12. In another implementation, the data throughput is detected by link monitor 16. Data throughput detection may include a calculation involving of the number of bits of the pattern transmitted, the number of bits received, the amount of communication protocol overhead (e.g., headers, checksums, retransmission), and the time for transmission, reception, and/or retransmission.

In another implementation, system 200 of FIG. 2 includes a wireless cell 12, a link monitor 16, wireless client 14, and link monitor 36. Wireless cell 12 and/or wireless client 14 selects a data pattern, transmits the data pattern, receives the data pattern, and detects (e.g., measures, calculates, monitors) a data throughput.

System 200 may detect a data throughput for a resource (e.g., antenna, radio, channel, attenuator, attenuation setting, wired connection, data pattern, transmission power setting, directionality of an antenna, communication protocol) for wireless cell 12 and/or wireless client 14 or for a combination of resources for either wireless cell 12 and/or wireless client 14.

Wireless cell 12 and wireless cell 14 may work independent of each other while detecting data throughput from their individual perspective or work together (e.g., cooperate) to determine data throughput for individual resources and/or a combination of resources.

System 200 may further select a resource and/or a combination of resources for communication responsive to a detected data throughput by wireless cell 12, wireless client 14, and/or a combination of wireless cell 12 and wireless client 14. Selection of a resource may be in response to the detected data throughput for the resource selected or for any other resource and/or a combination of resources.

In system 200, wireless cell 12 includes four directional antennas that form non-overlapping physical sectors 20, 22, 24, and 26. Link monitor 16 communicates with wireless cell 12 over link 18. Wireless client 14 includes four directional antennas that form non-overlapping physical sectors 28, 30, 32, and 34. No limitation prohibits antenna physical sectors from overlapping, for example, physical sectors 20 may at least partially overlap any physical sectors 22-26. Physical sectors 28, 30, 32, and 34 extend farther than depicted in FIG. 1 to enable communication with wireless cell 12, but they are drawn smaller to clarify the diagram. Link monitor 36 communicates with wireless client 14 over link 32. Wireless cell 12 wirelessly communicates with wireless client 14.

Link monitor 16 provides data patterns to wireless cell 12 for detecting data throughput over the wireless connection through each antenna of wireless cell 12 and for each available channel. Link monitor 36 provides data patterns to wireless client 14 for detecting data throughput over the wireless connection through each antenna of wireless client 14 and for each available channel.

The results of the data throughput detection may be used to select the antenna, channel, or other resource used by wireless cell 12 and/or wireless client 14 for wireless communication.

In one implementation using one method of operation, wireless cell 12 operates in a manner similar to the operation of system 100. In another implementation, wireless client 14 operates in a manner similar to the operation of system 100. In another implementation, wireless cell 12 and wireless cell 14 cooperate to detect data throughput. In one implementation, wireless cell 12 and wireless client 14 use patterns transmitted by the other to detect throughput. For example, wireless cell 12 and wireless cell 14 may be provided with a sequence of data patterns transmitted, such either wireless device knows the order of the data patterns and may detect data throughput with no additional interaction with the other wireless device. Either device may calculate data through put merely by reception of the data patterns.

In another implementation, wireless cell 12 and wireless cell 14 communicate to coordinate transmission and reception of data patterns.

Wireless cell 12 and wireless client 14 may share information (e.g., detected data throughput, data throughput with respect to specific resources, bit rate, retransmission information, resources tested, preferred resources).

Methods performed by a system, according to various aspects of the present invention provide, inter alia, data patterns, transmit data patterns, receive data patterns, select resources, transmit using selected resources, receive using selected resources, detect data throughput, and perform calculations related to data throughput.

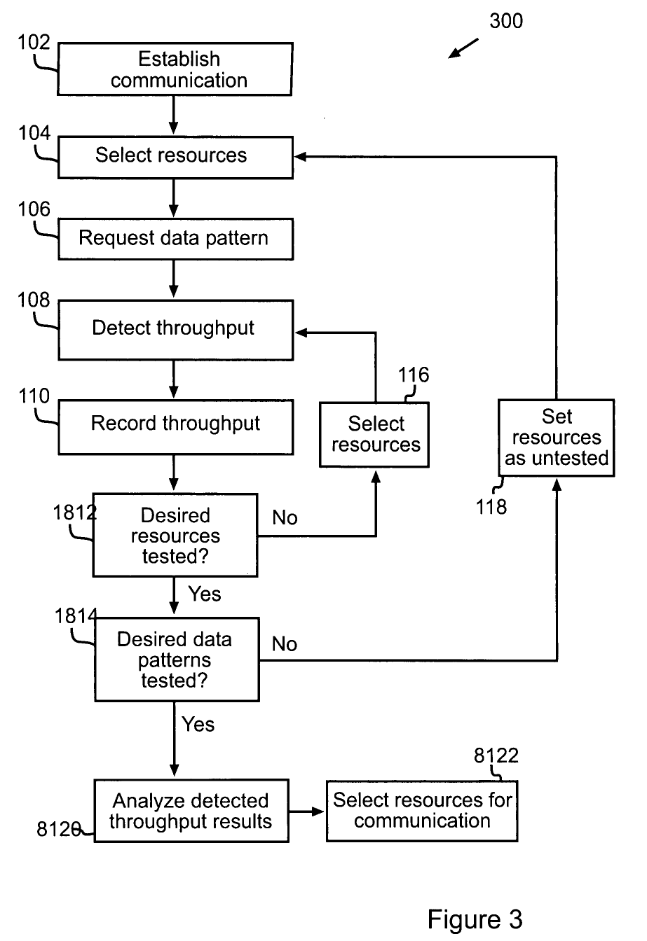

For example, method 300 of FIG. 3 provides a data pattern for detection of a data throughput. The data pattern may be transmitted and/or received through selected resources. Detected data throughput may be used to select resources. Additional communication may occur through selected resources.

For example, method 300 includes establish communication process 102, select resources process 104, request data pattern process 106, detect throughput process 108, record throughput process 110, desired resources tested process 112, desired data patterns tested process 114, select resources process 116, set resources as untested process 118, analyze detected throughput results process 120, and select resources for communication process 122.

Each process may perform its function whenever sufficient input information is available. For example, processes may perform their functions serially, in parallel, simultaneously, or in an overlapping manner. A system performing method 300 may implement one or more processes in any combination of programmed digital processors, logic circuits and/or analog control circuits. Inter-process communication may be accomplished in any conventional manner (e.g., subroutine calls, pointers, stacks, common data areas, messages, interrupts, asynchronous signals, synchronous signals, data packet). Method 300 is performed by a processor that controls other functional blocks of system 100 and/or system 200.

Establish communication process 102 includes any methods for establishing communication between wireless devices. For example, wireless cell 12 and/or wireless client 14 may establish wireless communication with each other using the methods of any conventional communication protocol. In one implementation, wireless client 14 associates with wireless cell 12 in any manner permitted by the I.E.E.E. 802.11a/b/g protocols.

Establish communication process 102 may establish communication between any number of wireless cells 12 and wireless clients 14.

Establish communication process 102 may include establishing communication between wireless cell 12 and link monitor 16 and/or communication between wireless client 14 and link monitor 36.

Select resources process 104 includes any methods for selecting a resource and/or a combination of resources. For example, wireless cell 12 may selected an antenna by controlling an RF multiplexer connected between a radio and at least one antenna. Wireless cell 12 may select a channel by controlling a radio to select a channel. Wireless cell 12 may select attenuation by setting the attenuation of an attenuator.

Select resources process 104 may use any criteria for selecting a resource. For example, wireless cell 12 and/or wireless client 14 may select an antenna that provides a threshold signal quality. Wireless cell 12 may select a channel in any manner permitted by the I.E.E.E. 802.11a/b/g protocols and wireless client 14 may detect and select the same channel.

Select resources process 104 may select resources in accordance with the communication protocol used in establish communication process 102. For example, wireless cell 12 may communicate with a first wireless client and a second wireless client. Resources selected to detect data throughput between wireless cell 12 and the first wireless client may be the same and/or different from the resources selected to detect wireless throughput between wireless cell 12 and the second wireless client.

Request data pattern process 106 includes any methods for selecting a data pattern, generating a data pattern, communicating a request to a device providing a data pattern, and delivering the data pattern to a requesting device. Any device may request a data pattern. Any device may provide a data pattern. For example, link monitor 16 may provide a data pattern to wireless cell 12 and/or wireless client 14. Data patterns may be communicated between devices without using the data pattern to detect data throughput. Data patterns may be communicated using wired and/or wireless connections.

Any number of link monitors may provide data patterns. In one implementation, referring to FIG. 2, link monitors 16 and 36 provide data patterns to wireless cell 12 and wireless client 14 respectively.

Data patterns may be communicated to any other device in any manner. A link monitor may communicate with any device in a system. For example, links 18 and 32, referring to FIGS. 1 and 2, may interface with wireless cell 12, wireless client 14, link monitor 16, and/or link monitor 36. In one implementation, link 18 is a wireless client-server interface that communicates with wireless cell 12 through a socket using TCP. In another implementation, link monitor 16 is a peripheral to wireless cell 12 and communicates via a local bus (e.g., I.E.E.E. 1394 parallel bus, AGP, PCI, infiniband, hypertransport, Universal Serial Bus (“USB”), MicroChanel, a high performance parallel interface). In another implementation, link monitor 16 is integrated into wireless cell 12 and link 18 is a local bus. In another implementation, the data throughput of link 18 is greater than the highest data throughput of the wireless connection between wireless cell 12 and wireless client 14. Link 18 may be implemented in any media (e.g., wireless, optical, electrical, mechanical).

Detect throughput process 108 includes any method for detecting throughput. Detect throughput process 108 may detect, inter alia, transmission rates, reception rates, errors rates, retransmission rates, retransmission requests, termination of communication, data received over time, data transmitted over time, data received as compared to a data rate threshold (e.g., video data rate), lost frame (e.g., video), and lost packets. Detect throughput process 108 may perform calculations (e.g., arithmetic, mathematical, statistical) and store information.

Detect throughput process 108 may detect any type of throughput (e.g., total throughput, usable data throughput, average throughput, maximum throughput, and minimum throughput).

In one implementation, data throughput may be detected by transmitting a data pattern from wireless cell 12 to wireless client 14, transmission the same data pattern from wireless client 14 to wireless cell 12, detecting a number of bits retransmitted, and calculating a throughput based on the rate of transmission, reception, and an amount of retransmissions. In another implementation, wireless client 14 transmits a data pattern to wireless cell 12, receives the same data pattern from wireless cell 12, detects a number of retransmitted data, and calculates a data throughput. In another implementation, wireless cell 12 and/or wireless cell 14 receives a predetermined data pattern, detects a number of bits retransmitted, and detects a throughput. In another implementation, wireless cell 12 and wireless client 14 cooperating in transmitting and receiving data patterns and detecting data throughput.

Calculations performed by detect throughput process 108 may be performed by any device or a combination of devices. Devices that may perform calculations may include wireless cell 12, wireless client 14, link monitor 16, link monitor 36, or any combination of the devices performing any portion of the calculation.

Calculations may include counting information (e.g., bit, byte, word, double word) transmitted or received, determining whether information is data or overhead (e.g., frame header, check sum), storing information, retrieving information, storing intermediate calculated results, retrieving intermediate calculated results, determining statistical importance of calculated results. For example, wireless cell 12, wireless client 14, and/or link monitor 16 may track the total number of bits received, the total number of usable data bits, the total number of bits transmitted, and the number of bits retransmitted.

Data patterns may facilitate the type of throughput detected. For example, a long data pattern may be used to facilitate measuring average data throughput. A pattern with a high likelihood of inducing errors may be used to measure maximum and/or minimum data throughput. In one implementation, wireless cell 12 uses a long video data pattern for at least one data pattern to measure average, minimum, and maximum data throughput by tracking the number of bits transmitted and the number of bits retransmitted. In another implementation, link monitor 16 provides a long video data pattern.

Record throughput process 110 includes any method for recording throughput. Record throughput process 110 may include storing throughput as a numeric value, all or portions of the information used to detect throughput, intermediate values of a calculation, and system configuration associated with a throughput valve. Record throughput process 110 may use any type of media and/or circuits for storing, retrieving, and reviewing throughput and/or other values store with throughput. Record throughput process 110 may correlate one throughput value to another throughput value whether from a current or a past performance.

In one implementation, data throughput results are stored in a look-up table implemented in system memory according to the antenna used by wireless cell 12, the antenna used by wireless client 14, data pattern used, and/or channel used for wireless communication.

Media used by record throughput process 110 may be physically located in any device that comprises the system. In one implementation of system 100, record throughput process 110 accesses storage media physically located in link monitor 16. In another implementation of system 100, storage media is apportioned between wireless client 12 and link monitor 16. In an implementation where storage media is located in various physical locations, record throughput process 110 uses any method of accessing the storage media (e.g., wired, wireless, messages, requests). In one implementation, record throughput process 110 uses link 18 to access storage media. In another implementation, wireless cell 12 performs record throughput process 110 to record it own detected data throughput and/or data throughput results for detected for wireless client 14.

Record throughput process 110 may further communicate detected throughput between devices in any conventional manner.

Desire resources tested process 112 includes any method for detecting whether a resource and/or a combination of resources has been used during detect throughput process 108. Desire resources tested process 112 may determine whether a resource and/or a combination of resources has been used during detect throughput process 108. For example, desire resources tested process 112 may determine whether an antenna, a radio, an RF multiplexer, a processor, an attenuator, or any combination thereof was selected during detect throughput process 108.

In one implementation, wireless cell 12 maintains a list of all antennas, radios, and channels. Wireless cell 12 performs desire resources tested process 112 to ensure that all antennas, radios, channels, and combinations thereof have be used during detect throughput process 108. In another implementation, referring to system 200, link monitor 16 performs desire resources tested process 112 to ensure that all antennas, radios, channels, and combinations thereof of wireless cell 12 and/or wireless client 14 have been used during detect throughput process 108.

Information as to the testing of desired resources may be maintained, reviewed, store, and verified in any manner. Data and values associated with desire resources tested process 112 may be stored in any media physically located in any device in the system.

Desire resources tested process 112 tracks the use of resources during detect throughput process 108 in any manner. In one implementation, desire resources tested process 112 maintains a table of each resource and/or a combination of resources for use during detect throughput process 108. Once a resource and/or a combination has been used during detect throughput process 108, desire resources tested process 112 indicates that the resource and/or combination has been tested. Until all resources and/or combinations are indicated as being tested, desire resources tested process 112 takes the branch marked “no” to select resources process 116. When all resources and/or combinations are indicated as being tested, desire resources tested process 112 takes the branch marked “yes” to desired data patterns tested process 114.

Select resources process 116 includes any methods for selecting a resource and/or a combination of resources. Select resources process 116 may be similar to or dissimilar to select resources process 104 to any extent. Select resources process 116 may receive information from any other process. In one implementation, select resources process 116 receives information as to which resources are to be selected for a next performance of detect throughput process 108. For example, select resources process 116 may select resources and/or a combination of resources that are indicated as being untested. Distinguishing between untested and tested resources may be determined in any manner. In one implementation, a processor of wireless cell 12 selects an antenna, a channel, and/or a combination thereof that has not been previously used during the detect throughput process 108.

In another implementation, link monitor 16 performs desired resources tested process 112 and select resources process 116 and performs selection of resources by sending appropriate commands to wireless cell 12, wireless client 14, and/or link monitor 36 for implementation of the selection. In another implementation, wireless cell 12 manages the selection of untested antennas and/or channels for both wireless cell 12 and wireless client 14.

In one implementation of process 300, detect throughput process 108, record throughput process 110, desired resources tested process 112, and select resources process 116 repeat until desired resources tested process 112 determines that all resources have been tested.

Desired data patterns tested process 114 includes any method for detecting whether a data pattern has been used during detect throughput process 108. Desired data patterns tested process 114 may determine whether a data pattern has been requested by a device, sent to a device over wired connection for use during detect throughput process 108, used during detect throughput process 108, transmitted wirelessly by a device, received wirelessly by a device, and recorded by record throughput process 110.

Desired data patterns tested process 114 may receive information as to desired actions to be taken for each data pattern. For example, desired data patterns tested process 114 may receive information stating that each data pattern is to be sent to a specific device for wireless transmission. Desired data patterns tested process 114 may record when the data pattern was sent to the device. Desired data patterns tested process 114 may further receive information from a device informing desired data patterns tested process 114 that the pattern has been transmitted wirelessly.

Desired data patterns tested process 114 may receive system information (e.g., communication protocol, number of wireless clients, number of wireless cells) and may select data patterns and actions responsive to system information received. Desired data patterns tested process 114 may further select actions for data patterns in accordance with the output of other processes, for example, detect throughput process 108 and/or record throughput process 110. In particular, desired data patterns tested process 114 may select an action for a data pattern in accordance with earlier detected data throughput.

In one implementation, link monitor 16 maintains a table of all data patterns and possible actions related to each data pattern. Link monitor 16 provides a default setting for each action of each data pattern. In one implementation, link monitor 16 provides a default setting that each data pattern should be sent to a device and wirelessly transmitted. In response to a request for a data pattern, link monitor 16 sends data patterns to wireless cell 12 over a wired link for transmission by wireless cell 12. Link monitor 16 records when it sends the data pattern to wireless cell 12. Link monitor 16 receives notice from wireless cell 12 upon transmission of the data pattern. Link monitor 16 records that the data pattern was transmitted. Link monitor 16 notes that all actions for the data pattern have been performed, thus the data pattern has been tested.

In another implementation, wireless cell 12 performs desired data patterns tested process 114 to determine if additional data patterns should be tested. In the event that additional data patterns are tested, wireless cell 12 marks the actions to be taken for the additional waveforms.

Until outstanding actions for data patterns have been completed, desired data patterns tested process 114 takes the branch marked “no” to set resources as untested process 118. When all actions for each data pattern have been taken, desired data patterns tested process 114 takes the branch marked “yes” to analyze detect throughput results process 120.

Set resources as untested process 118 includes any methods for indicating that a resource and/or a combination of resources is untested. The state of being untested may included not having been used during detect throughput process 108. Set resources as untested process 118 may send information to any other process to indicate that a resource and/or a combination of resources are untested. For example, set resources as untested process 118 may send information to desired resources tested process 112. In response to receiving information, desired resources tested process 112 may indicate that all or a portion of the resources and/or a combination of resources are untested.

In one implementation, upon receipt of a signal from set resources as untested process 118, desired resources tested process 112 indicates that all resources and combinations of resources are untested.

In one implementation of process 300, processes select resources 104, request data pattern 106, detect throughput process 108, record throughput process 110, desired resources tested process 112, select resources process 116, desired data patterns tested process 114, and set resources as untested process 118 repeat until desired data patterns process 114 determines that all data patterns have been tested.

Analyze detected throughput results process 120 includes any methods for analyzing data. Analyze detected throughput results process 120 may analyze data to compute a value, determine a result, detect a trend, make an operations decision, select resources, and provide information to another process. Analyze detected throughput results process 120 may perform, inter alia, mathematical operations, perform arithmetic operations, average, perform statistical analysis, perform regression testing, receive data, and convert data. Analyze detected throughput results process 120 may receive information from any other process.

In one implementation, analyze detected throughput results process 120 receives information from detect throughput process 108 and record throughput process 110. Analyze detected throughput results process 120 analyzes the information to determine which resource and/or combinations of resources provided a data throughput above a threshold value. Analyze detected throughput results process 120 may further determine a likelihood that a resource or a combination of resources may maintain a data throughput above a threshold value.

In one implementation, wireless cell 12 and/or link monitor 16 perform analyze detected throughput results process 120 to analyze data throughput detected for all combinations of tested resources, and determines which data throughputs detected are greater than a threshold data throughput.

Select resources for communication process 122 includes any methods for selecting a resource and/or a combination of resources. Select resources for communication process 122 may be similar to or dissimilar to select resources process 104 and/or select resources process 116 to any extent. Select resources for communication process 122 may receive information from any other process. In one implementation, select resources process 116 receives information as to which resources are to be selected for communication only from analyze detected throughput results process 120.

In one implementation, wireless cell 12 and/or link monitor 16 perform analyze detected throughput results process 120 and select resources for communication process 122 to analyze data throughput detected for all resources, select a resource and/or a combination of resources to provide a data throughput above a threshold to provide wireless communication between wireless cell 12 and wireless client 14.

Even after completion of select resources for communication process 122, detect throughput process 108 may operate to detect throughput based on any data stream communicated between wireless cell 12 and wireless client 14. Detect throughput process 108 may monitor data received over time to determine a throughput.

For example, wireless cell 12 and/or wireless client 14 may continuously monitor data flow during normal operation to detect an average, minimum, and/or maximum data throughput. In one implementation, after execution of select resources for communication process 122, wireless client 14 continuously monitors receive data while receiving video data. Using the information during normal operation, wireless client 14 wireless client 14 calculates average data throughput.

In another implementation, wireless client 14 is informed of a minimum video data rate. Wireless client 14 monitors receive video data and compares the receive data throughput to the minimum video data rate. Wireless client may report when the receive data rate falls below the minimum video data rate.

Generally, continuous throughput detection does not permit changes in resources without ceasing communication to select resources. While communication may continue indefinitely, communication may also be interrupted for another performance of all or part of method 300 when detected average, minimum, and/or maximum throughput falls below a threshold.

In one implementation, wireless cell 12 and/or link monitor 16 continuously detects data throughput for the data being sent during normal communication between wireless cell 12 and wireless client 14. When data throughput falls below a threshold, wireless cell 12 and/or link monitor 16 executes analyze detected throughput results process 120 to find a different resource and/or a combination of resources to provide a data throughput above the threshold. If a resource and/or a combination of resources exists, wireless cell 12 and/or link monitor 16 executes select resources for communication process 122 to configure wireless cell 12 for wireless communication using different resources. Wireless cell 12 restarts communication using the selected resources.

In the event that analyze detected throughput results process 120 does not identify a resource and/or a combination of resources that provide a data throughout greater than a threshold, method 300 executes anew to determine if any combination of resources will provide data throughput above a threshold.

In another implementation, method 400 of FIG. 3 provides data throughput detection, resource selection, analysis, and resource selection for communication for a system having resources that include antennas and channels. Method 400 includes establish communication process 402, request data pattern process 406, detect throughput process 408, record throughput process 410, have desired antennas been tested process 412, have desired channels been tested process 414, have desired data patterns been tested process 416, select an untested antenna process 418, select an untested channel process 420, set desired antennas as untested process 422, set desired channels as untested process 424, analyze data detected throughput results process 426, and select channel and/or antenna process 428.

Methods of detecting throughput may enable a wireless device (e.g., wireless cell, wireless client, link monitor) to perform the method while transmitting and receiving data patterns to a device not configured to perform the method. For example, a wireless cell 12 (or wireless cell 12 and link monitor 16 in combination) that performs the method transmits data patterns to a wireless client 14. Wireless client 14 is not adapted to perform the method, but does as a matter of normal communication transmit the data pattern back to the wireless cell.

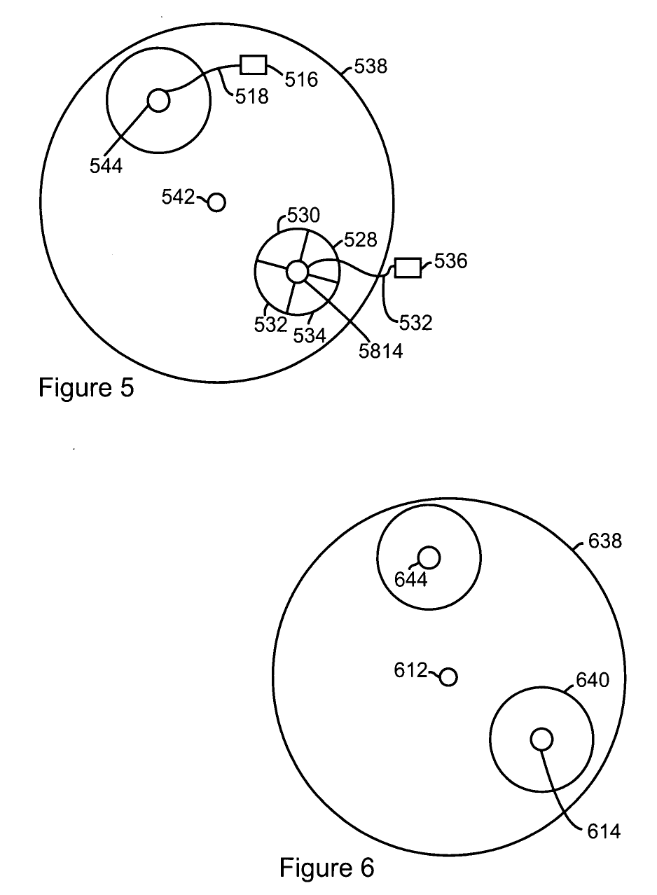

In another implementation, referring to FIG. 5, wireless cell 542 is an 802.11a/b/g access point having an omni-directional antenna with physical sector 538. Wireless cell 542 cannot perform a method for data throughput detection. Wireless client 514 is an 802.11a/b/g wireless client having four directional antennas forming non-overlapping physical sectors 528, 530, 532, and 534. Wireless cell 514 performs a method for detecting data throughput. No limitation prohibits antenna physical sectors of wireless client 514 from overlapping. Wireless client 544 is an 802.11a/b/g wireless client that performs a method for detecting data throughput. Wireless client 544 may have more than one antenna.

In this embodiment, wireless client 544 uses an omni-directional antenna. Link monitors 516 and 536 interface with wireless clients 544 and 514 using links 518 and 532 respectively. Links 518 and 532 may be any type of interface using any type of medium as disclosed above. Assume, for this embodiment, that wireless cell 542 and wireless clients 514 and 544 operate in the 802.11 managed mode, thus wireless cell 542 sets the channel of operation and wireless clients 514 and 544 select and use the same channel. Additionally, in the managed mode, wireless cell 542 operates to transport data between wireless clients 514 and 544. Wireless cell 542 may service wireless clients in addition to wireless clients 514 and 544.

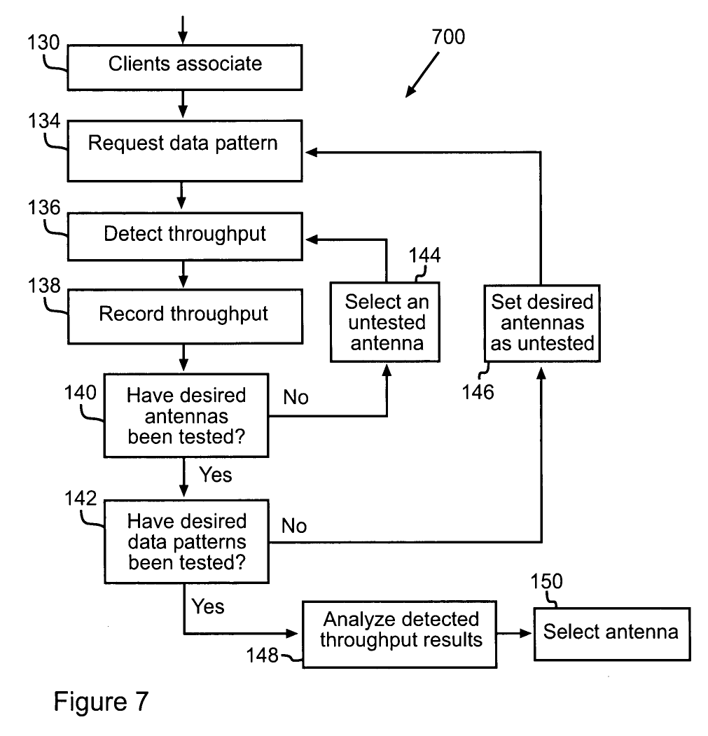

One implementation of a throughput detecting method, referring to FIG. 7, for the implementation depicted in FIG. 5, method 700 includes clients associate process 130, request data pattern process 134, detect throughput process 136, record throughput process 138, desired antennas tested process 140, desired data patterns tested process 142, select an untested antenna process 144, set antennas as untested process 146, desired data patterns tested process 142, analyzed detected throughput results process 148, and select antenna process 150.

An implementation of process 700 may include wireless client 514 and wireless client 544 associating with wireless cell 542 (e.g., process 130) and communicate with wireless cell 542 using the channel set by wireless cell 542. The data throughput detection mode may be initiated in any manner, for example, automatic initiation after association, initiation controlled by a single wireless client, and a negotiated initiation among several wireless clients.

Wireless clients 514 and/or 544 may request a data pattern from link monitor 16 and/or 36. The data pattern may be requested by any wireless client from any link monitor. For example, wireless client 514 may request a pattern from link monitor 536 which is transmitted to wireless client 544 by way of wireless cell 542. Wireless client 514 may request a data pattern from link monitor 516 which is transmitted to wireless client 514 by wireless client 544 by way of wireless cell 542. A data pattern request may include other similar permutations involving wireless client 544.

Data patterns, as mentioned above, may be adapted to detect data throughput in any manner. The data pattern may be transmitted and/or received to detect data throughput in any manner. In one implementation, referring to process 134 and 136, wireless client 514 requests a data pattern from link monitor 536 over link 532, transmits the pattern to wireless client 544 by way of wireless cell 542, and monitors receive data. Wireless client 544 may also function similarly by requesting and transmitting a pattern from link monitor 516.

In one implementation, wireless client 514 initiates throughput detection process 136 by communicating control information to wireless client 544. Wireless clients 514 and 544 may communicate control information in any manner, for example, using communication protocol compliant data packets containing control information, using a wireless connection on a channel different than the channel used to communicate with wireless cell 42, using a connection directly between wireless clients 514 and 544, and using a connection between wireless clients 514 and 544 though a wired network. In one implementation, wireless clients 514 and 544 communicate control information using communication protocol compliant data packets containing control information.

Detected throughput, referring to process 138, may be recorded in any manner and by any device. In one implementation, wireless client 514 records the detected throughput for each of its antennas.

In one implementation, only wireless client 514 includes more than one antenna, thus process 140 tests only the antennas of wireless client 514. Method 700 cycles through processes 140, 144, 136, and 138 to detect throughput through each antenna. Additionally, method 700 cycles through processes 142, 146, 134, 136, 138, and 140 to test all desired data patterns. The analysis of detected throughput, process 148, may be performed in any manner and by any device such as, for example, wireless cell 542, wireless client 514, wireless client 544, link monitor 516, link monitor 536, and any other device communicating with the network. In one implementation, wireless client 514 analyzes the detected data throughput and selects an antenna, shown as process 150.

In one implementation of FIG. 5, the wireless clients 514 and 544 may not be able to select a channel that provides a data throughput above a threshold, because wireless cell 542 controls channel selection and wireless cell 542 which cannot perform a method for detecting data throughput which includes selecting a channel in response to detected data throughput. In another implementation, wireless cell 542 controls antenna selection; however, wireless client 514 and/or wireless client 544 may request wireless cell 542 to change to a different channel. Wireless client 514 and/or wireless client 544 may repeat all or part of process 700 for each channel selected by wireless cell 542.

It is preferable that the link between a link monitor and a wireless device be a wired connection or be a wireless connection that has greater throughput that the wireless connection between wireless devices. Referring to FIG. 1, suppose that link 18 provides data throughput greater than the wireless connection between wireless cell 12 and wireless client 14, thus the delivery of data from data monitor 16 to wireless cell 12 is not a factor in measuring data throughput over the wireless connection between wireless cell 12 and wireless client 14. For example, suppose that the data throughput over link 18 is 60 Mbits/second, yet the data throughput over the wireless connection between wireless cell 12 and wireless client 14 is only 30 Mbits/second. Link 18 does not limit data throughput detection over the wireless connection because the data pattern is available to send at a rate that is greater than the throughput of the wireless connection.

Suppose however that link 18 provides less data throughput than the wireless connection between wireless cell 12 and wireless client 14. In such a case, link 18 may limit the data throughput detection of the wireless connection. For example, suppose that the data throughput over link 18 is 30 Mbits/second, yet the data throughput over the wireless connection between wireless cell 12 and wireless client 14 is 60 Mbits/second. The data throughput as detected over the wireless connection between wireless cell 12 and wireless client 14 may be only as high as the data throughput over link 18, thus even though the wireless connection can operate at a much higher rate, its measured rate is at the rate of data pattern delivery to wireless cell 12. Limitations in the data rate of link 18 may be overcome by including buffering in wireless cell 12 to buffer the data pattern for transmission.

In the implementations of FIGS. 1 and 2, links 18 and 32 may be designed such that their data throughput is at least as high as the wireless connection throughput, thus the measure throughput reflects the throughput of the wireless connection between wireless cell 12 and wireless client 14 and not link 18 and/or 32.

An implementation where all communication between devices is wireless, as shown in FIG. 6, may not provide an accurate throughput detection of each wireless connection between wireless devices. The wireless connection between wireless client 614 and wireless client 644 comprises a first wireless connection between wireless client 614 and wireless cell 612 and a second wireless connection between wireless cell 612 and wireless client 644. Unless wireless cell 612 is capable of performing data throughput detection, the throughput of the first wireless connection may not be measured independently of the second wireless connection.

For example, wireless client 614 attempts to detect throughput of the wireless connection between wireless client 614 and wireless cell 642 by transmitting a pattern from wireless client 614 to wireless client 644. The transmitted data travels the wireless connection from wireless client 614 to wireless cell 642 and the wireless connection from wireless cell 642 to wireless client 644. The throughput of each wireless connection is independent and possibly different, thus as given in the example above, the detected throughput is the throughput of the slowest wireless connection.

Wireless cell 642 may receive data and retransmit it back to the transmitting wireless client, thereby allowing wireless client 614 to measure either the first wireless connection or the second wireless connection.

Wireless devices may be adapted to facilitate data throughput detection throughout a network. For example, a link monitor may initiate data throughput measurement between wireless devices, receive detected data flow, receive detected data throughput, calculate data throughput, store measured throughput results, select antennas for wireless devices, select channels for wireless devices, and respond to reports of insufficient data throughput.

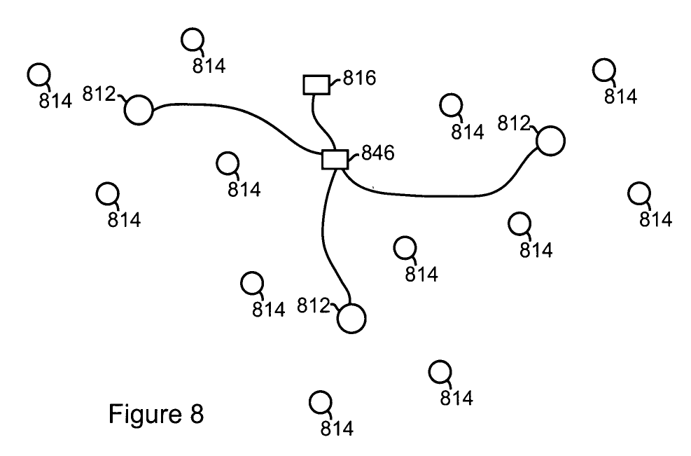

In one embodiment, referring to FIG. 8, network server 846 communicates with wireless cells 812 over a wired network. Link monitor 816 communicates with each wireless cell 812 through network server 846. Link monitor 816 initiates data throughput detection between a wireless cell 812 and its associated wireless clients 814. Each wireless cell 812 and wireless client 814 sends detected data throughput information to link monitor 816 for each antenna and/or channel. Link monitor 816 calculates a data throughput for each antenna/channel combination, and assigns antenna and/or channels to each wireless cell 812 and/or wireless client 814.

Link monitor 816 may receive messages from any wireless cell 812 and/or wireless client 814 that report insufficient data throughput. Upon receipt of a report of insufficient data throughput, link monitor 816 may, for example, reassign resources, initiate data throughput detection for selected wireless cells and/or wireless clients, deny service to selected wireless cells and/or wireless clients, and instruct selected wireless cells and/or wireless clients to locally deal with the insufficient data throughput condition.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

What is claimed is:

1. A method for detecting a data throughput and selecting a combination of resources for communicating, the method performed by a wireless cell having at least two resources, the method comprising:
establishing communication between the wireless cell and a provided wireless client;
transmitting a data pattern;
receiving the data pattern;
detecting a data throughput;
repeating transmitting, receiving, and detecting for each resource; and
responsive to detecting, selecting the combination of resources for communicating with the wireless client.

2. The method of claim 1 wherein the resources of the wireless cell comprise at least two antennas and at least two channels.

3. The method of claim 2 wherein selecting further comprises selecting one antenna and one channel.

4. The method of claim 1 further comprising receiving the data pattern from a link monitor.

5. The method of claim 1 wherein the data pattern comprises video data.

6. The method of claim 1 wherein the data throughput is an average data throughput.

7. The method of claim 1 wherein the data throughput is a maximum data throughput.

8. The method of claim 1 wherein the data throughput is a minimum data throughput.

9. The method of claim 1 wherein detecting further comprises detecting an amount of retransmitted data.

10. The method of claim 1 wherein selecting further comprises selecting the combination of resources such that the data throughput for the combination is greater than a threshold.

11. A method for detecting a data throughput and selecting a combination of resources for communicating between a wireless cell and a wireless client, the method performed by the wireless cell having at least two resources and the wireless client having at least two resources, the method comprising:
receiving a data pattern;
detecting a data throughput;
repeating receiving, and detecting for each resource; and
responsive to detecting, selecting the combination of resources for communicating.

12. The method of claim 11 wherein the data pattern comprises video data.

13. The method of claim 11 wherein detecting further comprises detecting an amount of retransmitted data.

14. The method of claim 11 wherein selecting further comprises selecting the combination of resources such that the data throughput for the combination is greater than a threshold.

15. The method of claim 11 wherein selecting is performed by the wireless cell.

16. A method for detecting a data throughput and selecting a combination of resources for communicating between a first wireless client and a second wireless client, the method performed by the first wireless client and the second wireless client, the first wireless client having at least two resources and the second wireless client having at least two resources, the method comprising:
associating with a provided wireless cell;
transmitting a data pattern to the other wireless client;
receiving the data pattern from the other wireless client;
detecting a data throughput;
repeating transmitting, receiving, and detecting for each resource; and
responsive to detecting, selecting the combination of resources for communicating.

17. The method of claim 16 wherein selecting is performed by the first wireless client.

18. The method of claim 16 wherein selecting is performed by the second wireless client.

19. The method of claim 16 wherein selecting further comprises selecting the combination of resources such that the data throughput for the combination is greater than a threshold.

20. The method of claim 16 wherein selecting further comprises selecting a resource used by the wireless cell.
